(19) United States
(12) Patent Application Publication
(10) Pub. No.: US 2013/0339603 A1
(43) Pub. Date: Dec. 19, 2013

(54) METHOD, APPARATUS AND SYSTEM FOR DETERMINING ACCESS TO A MEMORY ARRAY

(71) Applicants: Feng Zhu, San Jose, CA (US); Pranav Kalavade, San Jose, CA (US); Iwen Chao, Sacramento, CA (US)

(72) Inventors: Feng Zhu, San Jose, CA (US); Pranav Kalavade, San Jose, CA (US); Iwen Chao, Sacramento, CA (US)

(21) Appl. No.: 13/997,514

(22) PCT Filed: Dec. 23, 2011
(86) PCT No.: PCT/US11/67274

§ 371 Date: Jun. 24, 2013

(51) Int. Cl. G06F 3/06

(52) U.S. Cl. CPC G06F 3/0688; G06F 3/0638; G06F 3/0614
USPC 711/114

(57) ABSTRACT

Techniques and mechanisms for determining a sequence of accessed to a memory array. In an embodiment, a memory array includes multi-level cells and single-level cells interleaved with one another, where bits of the multi-level cells and single-level cells are variously allocated to different logical pages. In another embodiment, requests to access the memory array are ordered according to a sequence of page rounds to avoid an access event which includes a type of successive accessing of adjacent multi-level cells.

### BACKGROUND OF THE INVENTION

1. Field of the Invention

Embodiments discussed herein relate generally to control of accesses to a memory. More particularly, certain embodiments relate to determining an order of accesses to a memory cell array.

2. Background Art

In conventional flash memory techniques such as for NAND flash, there are at least two significant constraints which limit cycling capability: intrinsic charge loss/quick charge loss (ICL/QCL) and program disturb/over program (PD/OP).

To provide high-level reliability in endurance and data retention, current solid state drive systems such as those used in enterprise applications typically implement a 1 bit/cell—or single-level cell (SLC)—storage scheme. In a SLC storage scheme, a memory cell has a threshold voltage (Vt) distribution for accommodating a single, exclusive bit for variously storing either a logic level “1” or a logic level “0.” As a result, there is usually enough read window budget (RWB) in a SLC to accommodate degraded ICL/QCL and/or PD/OP.

On the other hand, 2 bits/cell—or multi-level cell (MLC)—storage schemes have comparatively more limited cycling capability. In an MLC storage scheme, a memory cell has four or more levels of threshold voltage (Vt) distribution for accommodating at least two bits, so RWB is comparatively tight. Due to the large neighboring-cell Vt swing, MLC storage schemes suffer from significant cell-to-cell interference, including wordline-to-wordline (WL-WL) floating-gate-to-floating-gate (FG-FG) capacitive coupling and bitline-to-bitline (BL-BL) FG-FG capacitive coupling.

Despite their reliability, SLC schemes are usually associated with higher fabrication costs, as compared to MLC storage schemes. As a result, existing flash memory technology imposes a significant tradeoff between cost and cycling capability.

### BRIEF DESCRIPTION OF THE DRAWINGS

The various embodiments of the present invention are illustrated by way of example, and not by way of limitation, in the figures of the accompanying drawings and in which:

FIG. 1 is a circuit diagram illustrating elements of a conventional floating gate transistor.

FIG. 2A is a block diagram illustrating elements of a memory array according to various embodiments.

FIG. 2B is a block diagram illustrating elements of a memory array according to various embodiments.

FIG. 3 is a block diagram illustrating elements of a computer platform for performing memory accesses according to an embodiment.

FIG. 4 is a block diagram illustrating elements of a memory system for determining an order of memory accesses according to an embodiment.

FIG. 5 is a block diagram illustrating elements of a memory array according to an embodiment.

FIG. 6 is a block diagram illustrating elements of a memory device for determining an order of memory accesses according to an embodiment.

FIG. 7 is a flow diagram illustrating elements of a method for determining an order of memory accesses according to an embodiment.

FIG. 8 is a flow diagram illustrating elements of a processing of memory access information according to an embodiment.

FIGS. 9A and 9B are tables illustrating elements of respective page round sequences for ordering memory accesses according to various embodiments.

### DETAILED DESCRIPTION

Embodiments discussed herein variously provide for an ordering of accesses to a memory array to avoid one or more types of successive accesses to adjacent multi-level cells. Certain embodiments provide for cell-adjacent MLC-SLC pairs in a memory array, where such pairs reduce (or eliminate) instances of MLC-MLC adjacency in the memory array. Alternatively or in addition, a paging of bits to respective pages and a sequence of page rounds may be used to reduce the likelihood of access events which include what is referred to herein as a successive-adjacent MLC-MLC access.

Various embodiments are discussed herein with reference to a set of cells which is a “cell-contiguous” set, meaning that for any two cells in the set, any cell between those two cells is also in the set. Similarly, cells are “cell-adjacent” to one another no other cells are between them.

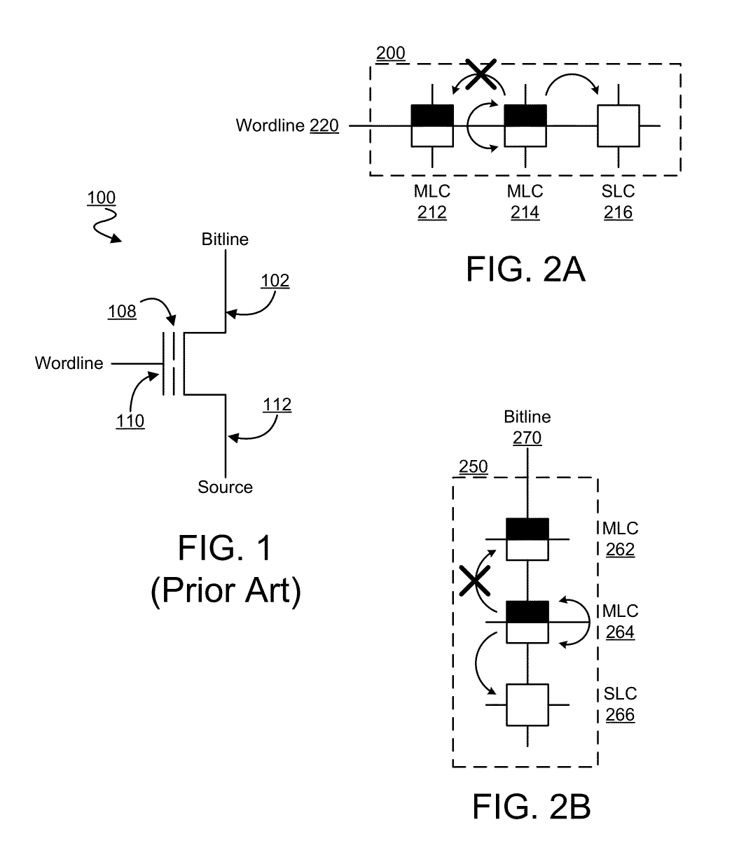

FIG. 1 shows a schematic representation of a conventional floating gate (FG) transistor 100. FG transistor 100 is illustrative of one type of transistor which may be adapted for use in a multilevel cell (MLC) of a memory array, according to an embodiment. FG transistor 100 may include a channel region between a drain node 102, a source node 112, and a control gate 110 over the channel region. In addition, FG transistor 100 may have a FG (shown schematically at 108) between control gate 110 and the channel region. FG 108 may be electrically isolated from control gate 110 and the channel region when nominal voltages are applied across the various terminals. A flash memory device may have a large number of FG transistor flash cells in an array—e.g. where the control gate of each flash cell is connected to a word line and the drain is connected to a bit line, the flash cells being arranged in a grid of word lines and bit lines.

A flash memory cell may, for example, be programmed by inducing hot electron injection or Fowler-Nordheim tunneling from the channel region to FG 108 through the gate oxide by applying a relatively high control gate voltage and nominal drain voltage. The voltage at control gate 110 determines the amount of charge residing on FG 108 after programming. The charge affects current in the channel region by determining the voltage that must be applied to control gate 110 in order to allow the flash cell to conduct current between source node 112 and drain node 102. This “threshold voltage” of the flash cell is the physical form of the data stored in the flash cell. As the charge on FG 108 increases the threshold voltage also increases.

In an embodiment, a memory array includes a plurality of memory cells—e.g. each cell including a respective transistor having some or all of the features of FG transistor 100. For example, such a plurality of memory cells may include first cells, each of which having threshold voltage distributions for operation as a MLC. Alternatively or in addition, the plurality of memory cells may include second cells, each of which having threshold voltage distributions for operation as a SLC.

In an embodiment, access to such a plurality of memory cells may be ordered according to a sequence—e.g. where the ordering according to the sequence is to reduce the likelihood of an access error which may result from one or more types of bit access sequences.

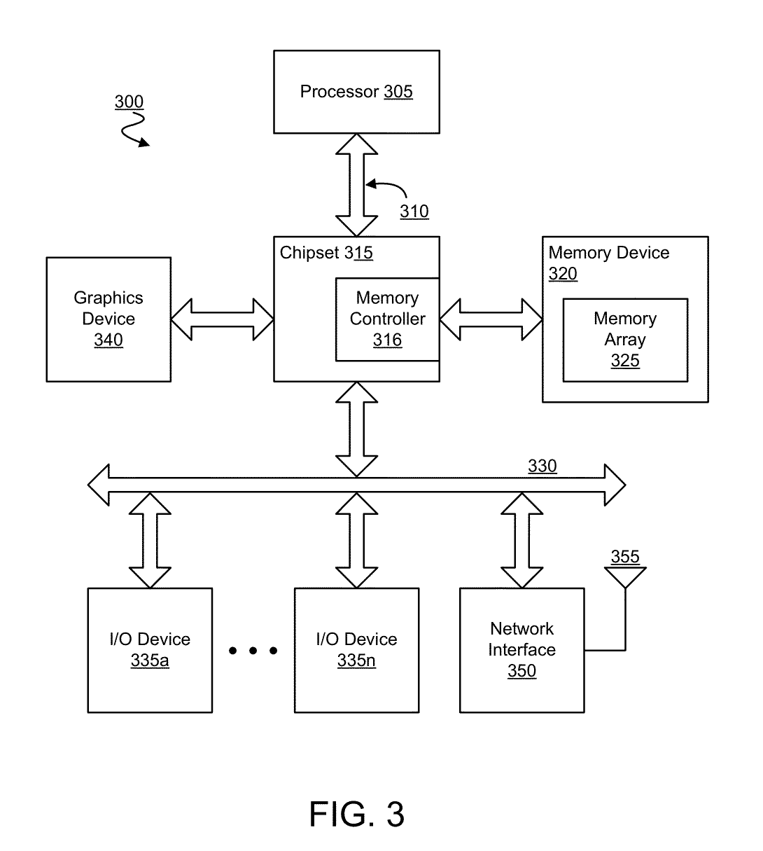

For example, FIG. 2A provides a block diagram view illustrating elements of a plurality of memory cells 200 in a memory array according to an embodiment. The plurality of memory cells 200 are illustrative of one type of set of cell-contiguous memory cells which, according to an embodiment, includes one or more of what is referred to herein as a “cell-adjacent MLC-SLC pair”—i.e. a pair of memory cells which are cell-adjacent to one another along a direction of some cell activation line, the pair including one MLC and one SLC.

By way of illustration and not limitation, the plurality of memory cells 200 may include a cell-adjacent MLC-SLC pair including a MLC 214 and a SLC 216. At least some of the plurality of memory cells 200 may share a cell activation Line—e.g. a wordline 220. The MLC, SLC (or SLC, MLC) order in a cell-adjacent MLC-SLC pair is not limiting on certain embodiments. Also, the plurality of memory cells 200 may include one or more additional memory cells (not shown). For the purpose of illustrating a type of event to be avoided according to different embodiments, MCL 214 is shown as being adjacent to an MLC 212 in a direction of wordline 220.

Various techniques and/or mechanisms may be provided, according to different embodiments, for avoiding one or more types of access events. To illustrate features of different embodiments, certain types of access events are discussed herein with respect to an access of a MLC 214. However, such discussion may be extended to also apply to events which might access an MLC cell in any of a variety of additional or alternative memory arrays.

Access to a bit of MLC 214 may result in FG field characteristics which pose a risk of FG-FG capacitive coupling—e.g. vis-à-vis a subsequent access to a bit of another memory cell which is cell-adjacent to MLC 214. The risk is particularly significant if such a subsequent access is during an access cycle immediately following the access to MLC 214 and/or if the next accessed, cell-adjacent bit is another MLC, such as MLC 212. For brevity, such a situation is referred to herein as a “successive-adjacent MLC-MLC access”.

Various embodiments avoid one or more types of successive-adjacent MLC-MLC accesses—e.g. by a distribution of both MLCs and SLCs in one or more MLC-SLC pairs along at least one shared cell activation line in a memory array. In certain embodiments, a successive-adjacent MLC-MLC access may be avoided by further using an allocation of bits in such MLCs and SLCs to various respective logical pages. In an embodiment, a successive-adjacent MLC-MLC access may be avoided by further using a sequence of page rounds (or simply a “page round sequence”)—e.g. where each page round in the page round sequence is for accessing a different respective one of such a plurality of logical pages.

In an illustrative scenario, some first bit of MLC 214 may belong to a first logical page in a plurality of logical pages of memory cells 200. An access to that first bit of MLC 214 may take place during some first page round in a sequence of page rounds—e.g. where that first page round is dedicated for accessing the first logical page.

In such a scenario, certain embodiments variously provide that any page round which immediately follows the first page round in the page round sequence will not access a page having a bit of any MLC which is cell adjacent to MLC 214 in the direction of at least one cell activation line. Stated differently, any MLC cell which might be cell-adjacent to MLC 214, at least in a direction of one cell activation line, does not include a bit which belongs to a logical page to be accessed in the next page round of the page round sequence.

Accordingly, a successive-adjacent MLC-MLC access involving MLC 214 may be avoided at least in part by not having any MLC adjacent to MLC 214—e.g. adjacent at least along the direction of wordline 220 and/or along a direction of the bitline for MLC 214. Additional paging and page round sequencing techniques may also be provided—e.g. to avoid any successive-adjacent MLC-MLC accesses in a larger plurality of cell-contiguous memory cells.

FIG. 2B provides a block diagram view illustrating elements of a plurality of memory cells 250 according to another embodiment. The plurality of memory cells 250 are illustrative of cell-contiguous memory cells including a cell-adjacent MLC-SLC pair sharing a bitline 270. More particularly, the plurality of memory cells 250 may include a cell-adjacent MLC-SLC pair including MLC 264 and SLC 266. The plurality of memory cells 250 may include one or more additional memory cells (not shown). For the purpose of illustrating a type of event to be avoided according to different embodiments, MCL 264 is shown as being adjacent to an MLC 262 in a direction of bitline 270.

Techniques to avoid a successive-adjacent MLC-MLC access along a wordline may, in an embodiment, be adapted to additionally or alternatively avoid a successive-adjacent MLC-MLC access along a bitline such as bitline 270. By way of illustration and not limitation, embodiments may variously avoid an access to MLC 264 being followed in some immediately succeeding access round by an access to any MLC, such as MLC 262, which might be cell-adjacent to MLC 264 along a direction of shared bitline 270.

For example, a successive-adjacent MLC-MLC access involving MLC 264 may be avoided at least in part by not having any MLC adjacent to MLC 264—e.g. adjacent at least along the direction of bitline 270 and/or along a direction of the wordline for MLC 264. Additional paging and page round sequencing techniques may also be provided—e.g. to avoid any successive-adjacent MLC-MLC accesses in a larger plurality of cell-contiguous memory cells.

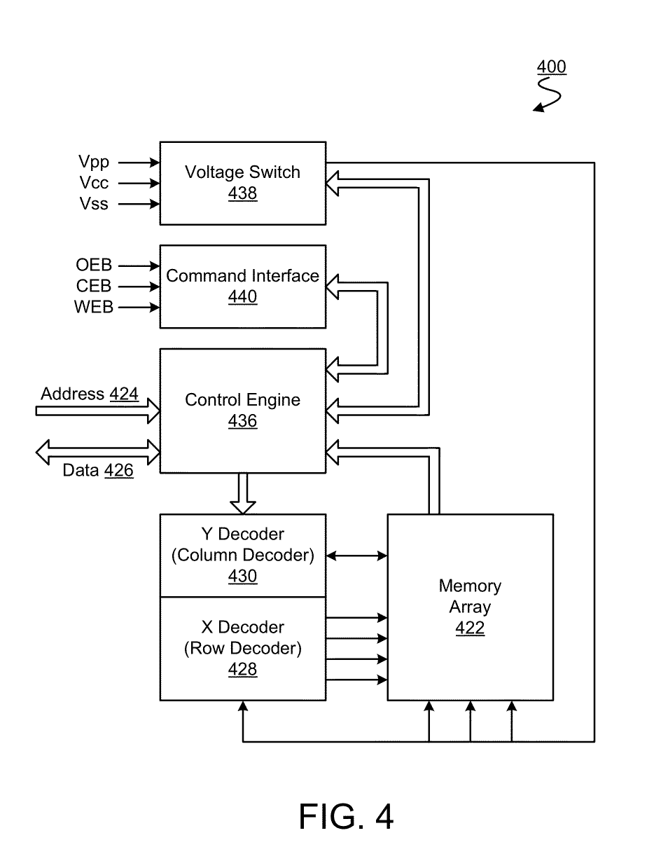

FIG. 3 illustrates elements of a computer platform 300 for processing memory access requests according to an embodiment. Computer platform 300 may, for example, include a hardware platform of a personal computer such as a desktop computer, laptop computer, a handheld computer—e.g. a tablet, palmtop, smartphone, media player, and/or the like—and/or other such computer system. Alternatively or in addition, computer platform 300 may provide for operation as a server, workstation, or other such computer system.

In an embodiment, computer platform 300 includes a processor 305 and a chipset 315 coupled thereto—e.g. by way of a host bus 310. Processor 305 may include an application processor, a microcontroller, a central processing unit etc. of any of a variety of types of single core or multi-core architectures, such as a CISC, RISC, VLIW, a hybrid architecture, and/or the like. In addition, processor 305 may be implemented on one or more chips. Chipset 315 may be further coupled to a memory device 320 of computer platform 300, the memory device 320 including a memory array 325.

Chipset 315 may include a memory controller 316 coupled to memory device 320 (e.g., where memory array 325 of memory device 320 includes flash memory cells such as NAND flash memory cells) and, in an embodiment, one or more interface devices (not shown) to collect, group, prioritize and/or otherwise prepare requests to access memory array 325—e.g. including requests from various busses of computer platform 300—and funnel such requests to memory controller 316.

Chipset 315 may also be responsible for various bridging for processor transactions with one or more other components of computer platform 300. By way of illustration and not limitation, computer platform 300 may further include a graphics device 340—e.g. coupled by way of an Accelerated Graphics Port. Graphics device 340 may, for example, provide touchscreen input functionality, although certain embodiments are not limited in this regard. Alternatively or in addition, computer platform 300 may include one or more other I/O devices, represented by the illustrative I/O devices 335a, . . . , 335n coupled via an I/O bus 330. I/O bus 330 represents any of a variety of combinations of one or more interface mechanisms including, but not limited to, various busses (e.g., PCI, ISA, X-Bus, EISA, VESA, etc.), bridges (also termed as bus controllers) and/or the like.

I/O devices 335a, . . . , 335n may, for example, include a keyboard or other such device including alphanumeric and/or other keys to receive user input. Additionally or alternatively, I/O devices 335a, . . . , 335n may include a cursor control device such as a mouse, a trackball, a pen, a touch screen, cursor direction keys and/or the like to communicate position, selection or other cursor information to processor 305, and/or to control cursor movement—e.g. on graphics device 340. I/O devices 335a, . . . , 335n may additionally or alternatively include a gyroscopic sensor to provide position, motion and/or orientation information, a hard copy device such as a printer, a sound record/playback device such as a microphone or speaker or any of a variety of combinations of additional or alternative hardware for providing I/O with computer platform 300.

Computer platform 300 may additionally or alternatively include a network interface device 350 for connecting computer platform 300 to one or more networks (not shown)—e.g. including a dedicated storage area network (SAN), a local area network (LAN), a wide area network (WAN), a virtual LAN (VLAN), an Internet and/or the like. For example, network interface device 350 may include one or more of a network interface card (NIC), a wired or wireless modem, a wireless transceiver, etc.—e.g. for computer platform 300 to exchange messages according to any of a variety of wireless communication standards such as 3G, WiMAX, Long Term Evolution (LTE), LTE Advanced and/or the like. For example, network interface device 350 may include or otherwise operates with an antenna 355 such as a dipole antenna, although the scope of the present invention is not limited in this respect.

During operation, processor 305 and/or other hardware of computer platform 300 may, for example, exchange one or more requests for respective accesses to memory array 325. Embodiments variously provide techniques and/or mechanisms for determining an order of such memory accesses. For example, memory device 320 may include sequencing logic to order accesses to memory array 325 according to a sequence which accounts for a distribution of MLCs and SLCs in memory array 325 and/or an allocation of bits in such MLCs and SLCs to respective pages. In an alternate embodiment, such sequencing logic may be provided in another memory device such as memory controller 316. In an embodiment, some or all of the controller functionality of memory controller 316 may be incorporated into an integrated circuit for processor 305, although certain embodiments are not limited in this regard.

The architecture of computer platform 300 is illustrative of one computer system for determining a sequence of memory accesses according to an embodiment. However, the architecture of computer platform 300—e.g. the particular number and types of devices coupled to request, sequence or otherwise determine accesses to memory array 325 and/or the relative configuration of such devices with respect to one another—may not be limiting on certain embodiments. By way of illustration and not limitation, memory device 320 may alternatively be coupled to chipset 315 via I/O bus 330—e.g. where memory device 320 includes a solid-state drive to exchange SATA communications via I/O bus 330, where memory device 320 plugs into a USB connector to I/O bus 330 and/or the like.

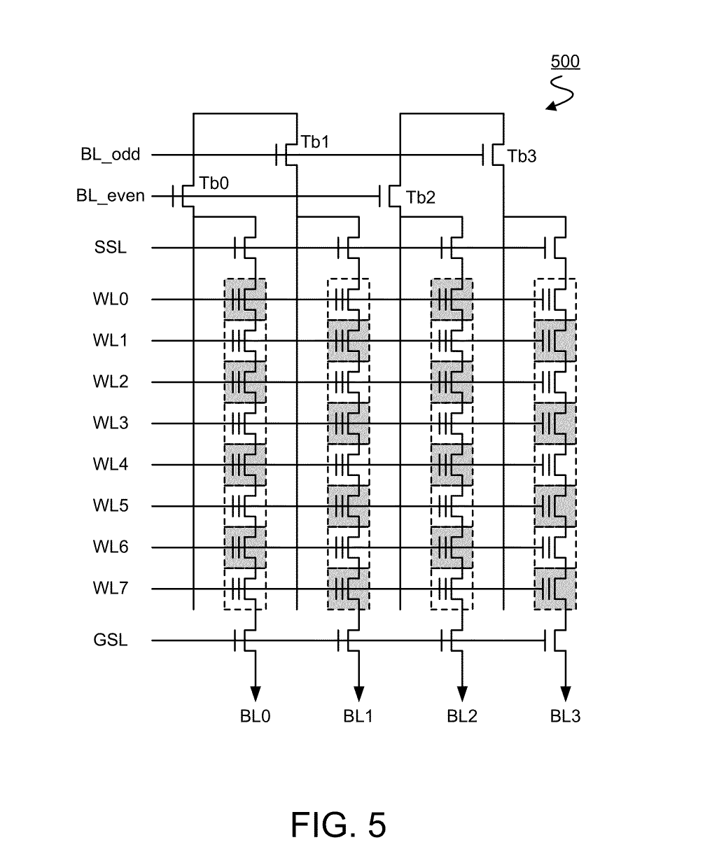

FIG. 4 illustrates in block diagram form elements of a memory system 400 for processing memory access requests according to an embodiment. Memory system 400 may reside within computer platform 300, for example. In an embodiment, memory system 400 resides in a memory device having some or all of the features of memory device 320. In an alternate embodiment, memory system 400 spans multiple devices including such a memory device and a controller device—e.g. memory controller 316.

Although certain embodiments are not limited in this regard, memory system 400 may be fabricated on a single semiconductor substrate and store data using nonvolatile memory cells within memory array 422. Memory system 400 may be configured to use various sets of threshold voltages for storing data in different respective nonvolatile (e.g. flash) memory cells of memory array 422. Memory array 422 may, for example, include any type of memory cell with programmable threshold voltages, such as memory cells with trapping dielectrics or floating gates. In one embodiment, memory array 422 is comprised of NAND flash memory cells.

In one embodiment, memory system 400 includes a control engine 436 including circuit logic to control read and/or write accesses to memory array 422. Control engine 436 may also control selective programming of individual cells—e.g. for each such cell to operate as a respective one of a SLC and a MLC, as described in detail herein. For example, control engine 436 may include a microcontroller or other processor logic—e.g. to execute microcode stored in an on-chip memory. However, various other types of hardware may be provided in control engine 436 to implement, according to different embodiments, techniques for determining a sequence of accesses to memory array 422.

Control engine 436 may receive on address lines 424 signals specifying one or more locations of memory array 422 to be accessed. An X decoder 428 of memory system 400 may select an appropriate row (e.g. wordline) within memory array 422 in response to address signals applied to address lines 424. For this reason, X decoder 428 may also be called a row decoder. Similarly, a Y decoder 430 of memory system 400 may select an appropriate column (e.g. bitline) within memory array 422 in response to address signals from address lines 424. Because of its function, Y decoder 430 may also be called a column decoder.

Control engine 436 may manage access to memory array 422—e.g. via control of X decoder 428, Y decoder 430 and a voltage switch 438. Voltage switch 438 may control various voltage levels necessary to read, program and/or erase data in memory array 422. By way of illustration and not limitation, voltage switch may operate based on one or more of a device power supply Vcc, a ground Vss and a program/erase voltage Vpp for programming or erasing data stored within memory array 422. Vpp may be externally supplied or internally generated—e.g. varied—by voltage switch 438.

User commands for reading, erasure, and programming may be communicated to control engine 436—e.g. via a command interface 440 of memory system 400. In an embodiment, an external agent may directly or indirectly issue commands to command interface 440—e.g. via one or more of three control pins: output enable OEB, write enable WEB, and chip enable CEB.

Certain mechanisms of memory system 400 for performing an individual cell bit access are merely illustrative, and are not limiting on certain embodiments. For example, a particular bit access in a determined sequence of ordered accesses of memory array 422 may, in and of itself, be implemented with any of a variety of conventional mechanisms for performing such a bit access. However, a system such as memory system 400 may further include mechanisms for determining, according to an embodiment, a sequence of accesses to memory array 422. Such mechanisms may be variously located in—e.g. distributed across—one or more of control engine 436, command interface 440, X decoder 428 and/or Y decoder 430, although certain embodiments are not limited in this regard.

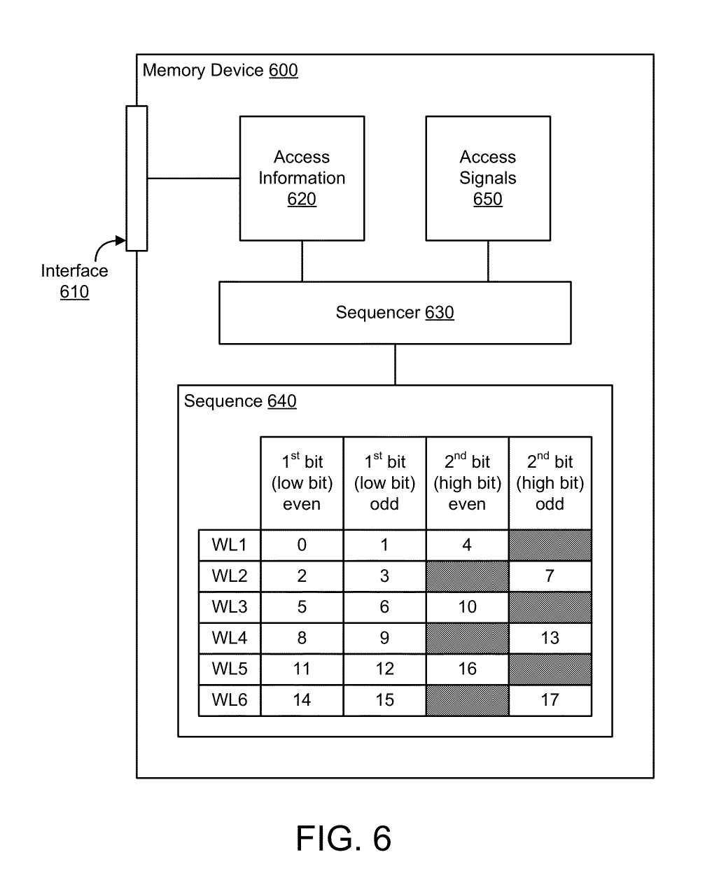

FIG. 5 illustrates elements of a memory array 500 which, for example, is to be a target of memory accesses ordered according to an embodiment. In an embodiment, memory array 500 includes some or all of the features of memory array 422.

Memory array 500 may include wordlines, bitlines and memory cells which each correspond to—e.g. which are each activated by—a different respective combination of one of the wordlines and one of the bitlines. By way of illustration and not limitation, memory array 500 may include a plurality of wordlines and bit lines—represented by the illustrative wordlines WL0, . . . , WL7 and bitlines BL0, . . . , BL3—and respective memory cells variously accessible thereby. Memory array 500 may further include one or more conventional circuit elements—e.g. a source select line (SSL), a ground select line (GSL) and/or the like—to aid in reading from and/or writing to the individual memory cells.

Of the memory cells in memory array 500, some cell-contiguous set of such memory cells may include both first cells to operate as MLCs and second cells to operate as SLCs. For example, both MLCs and SLCs may be located on the same wordline and/or both MLCs and SLCs may be located on the same bitline. In an embodiment, at least some of the first cells may be interleaved with at least some of the second cells. For example, at least some sub-set of the cell-contiguous set may be cells which are cell-adjacent in a line along a direction of a given cell activation line, where such cell-adjacent cells form alternating MLCs and SLCs along that line. In certain embodiments, MLCs and SLCs are interleaved with one another along a wordline direction of one of WL0, . . . , WL7, while other MLCs and SLCs are interleaved with one another along a bitline direction of one of bitlines BL0, . . . , BL3.

As shown in FIG. 5, memory array 500 may provide for interleaving across both multiple bitlines and multiple wordlines. For example, a distribution of the first cells to operate as MLCs and a distribution of the second cells to operate as MLCs may form a checkered pattern in memory array 500. Such a checkered pattern is illustrated by a grey highlighting of alternate memory cells in memory array 500 (e.g. where grey highlighting indicates memory cells to operate as MLCs, for example).

Such checkered or otherwise interleaved distributions of memory cells may result in memory array 500 having multiple cell-adjacent MLC-SLC pairs which have an average of 1.5 bits/cell storage capacity. With such cell-adjacent MLC-SLC pairs, paging mechanisms—and, in an embodiment, page round sequence mechanisms—may be utilized to provide for memory access sequences which avoid at least certain types of successive-adjacent MLC-MLC access events. For example, memory array 500 may include control signal lines BL_even and BL_odd each for accessing multiple bit lines as a group—e.g. for activating transistors Tb0, Tb2 to access an even bitline group including bit lines BL0 and BL2, or for activating transistors Tb1, Tb3 to access an odd bitline group including bit lines BL1 and BL3. Control signals BL_even and BL_odd represent a hardware implementation to provide a paging scheme which distinguish pages at least on a bitline group basis. In other embodiments, such paging schemes may, for example, be implemented at least in part by firmware or other code executing in memory controller logic.

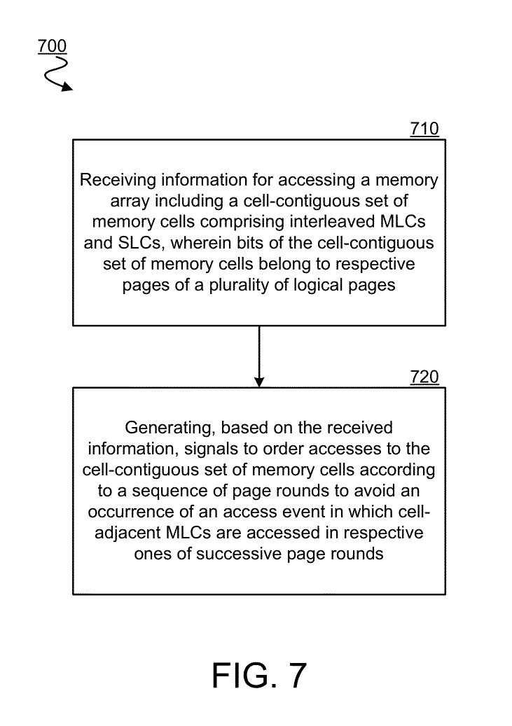

FIG. 6 illustrates elements of a memory device 600 for determining, according to an embodiment, an order of memory accesses to be performed. Memory device 600 may provide some or all of the functionality of a memory system such as that of memory system 400. For example, memory device 600 may include one or more features of control engine 436.

In an embodiment, memory device 600 includes a hardware interface 610 to receive access information 620 for accessing a memory array such as memory array 325. Hardware interface 610 may, for example, receive signals—such as those received on address lines 424 and/or data lines 426—which include or otherwise represent multiple access requests, each for a respective logical address corresponding to some physical memory location(s) in memory array 422.

Memory device 600 may include a sequencer 630 coupled to hardware interface 610, the sequencer 630 including circuit logic to generate, based on the received access information 620, access signals 650 to order accesses to a cell-contiguous set of memory cells of the memory array. In an embodiment, the ordering to be achieved by access signals 650 may be according to a sequence 640 of page rounds, each page round for accessing one—e.g. only one—page of a plurality of logical pages of the memory array. Sequence 640 may, for example, represent a lookup table or other such repository for storing information representing some predetermined sequential performance of page rounds. Such a repository may be stored locally in memory device 600, although certain embodiments are not limited in this regard. Such information may be accessed by sequencer 630 to determine an ordering—e.g. a reordering—of memory accesses represented by the received access information 620. In an alternate embodiment, sequence 640 is a set of one or more state machines or other such logic which provides a hard-wired implementation of such a sequential performance of page rounds.

In the memory array targeted by the accesses represented in access information 620, a cell-contiguous set of memory cells may include MLCs and SLCs which are interleaved at least in part with one another—e. g. where multiple cell-adjacent MLC-SLC pairs are located at least along a wordline or along a bitline of the cell-contiguous set. In an embodiment, the cell-contiguous set of memory cells, due to multiple cell-adjacent MLC-SLC pairs, have an average of one and a half bits per cell. A distribution of MLCs and a distribution of SLCs may, for example, form a checkered distribution pattern in the cell-contiguous set. The memory array may be located within memory device 600, although certain embodiments are not limited in this regard.

In an embodiment, bits of the cell-contiguous set of memory cells variously belong to respective pages of a plurality of logical pages. By way of illustration and not limitation, one or more wordlines of the memory array may each correspond to a different respective set of logical pages—e.g. where, for each of such one or more wordlines, each logical page in the corresponding set of logical pages includes only bits which are accessed via that wordline.

In an illustrative scenario, a first wordline—e.g. WL1—of the memory array may provide access to first memory cells which operate as MLCs, each MLC including a respective first bit for representing a logical state and a respective second bit for representing a logical state. The respective first bits of the first memory cells may be associated with one another—for example, where the first bits are associated with the same (e.g. lower) readout voltage. Similarly, the respective second bits of the first memory cells may, for example, be similarly associated with one another by some same (e.g. higher) readout voltage. The first wordline may further provide access to second memory cells which operate as SLCs, each SLC including a respective exclusive bit for representing a logical state. The respective exclusive bits of the second memory cells may, for example, be associated with one another—e.g. by some same readout voltage.

A paging scheme according to one embodiment may implement a set of pages corresponding to such a first wordline—e.g. the set of pages including a first logical page having (e.g. having only) first bits of the first memory cells which are to be accessed with the first word line. Additionally or alternatively, such a set of pages may include a second logical page having (e.g. having only) second bits of the first memory cells which are to be accessed with the first word line. Additionally or alternatively, such a set of pages may include a third logical page having (e.g. having only) exclusive bits of the second memory cells which are to be accessed with the first word line.

In an embodiment, some or all of the logical pages of a memory array are distinguished from one another on one or more of a wordline basis, an even/odd bitline basis and a first/second bit basis. In an illustrative paging scheme indicated in sequence 624, the memory array includes eighteen (18) logical pages—e.g. wherein respective sets of three logical pages each correspond to a different one of wordlines WL1, . . . , WL6 of the memory array. For each of wordlines WL1, . . . , WL6, first bits of MLCs accessed with that wordline comprise one page, second bits of MLCs accessed with that wordline comprise a second page, and exclusive bits of SLCs accessed with that wordline comprise a third page. Moreover, the sets of pages for successive adjacent wordlines in WL1, . . . , WL6 alternate between having two pages each for respective even bitline MLC bits (with one page for odd bitline SLC bits) and having two pages each for respective odd bitline MLC bits (with one page for even bitline SLC bits). The paging scheme indicated in sequence 624 is merely illustrative of one scenario, and may, for example, be extended to apply to a memory array including any of a variety of additional or alternative wordlines, any of a variety of additional or alternative MLC-SLC checkered distribution patterns, and/or the like.

With a given distribution of MLCs and SLCs in the memory array and a given paging scheme variously allocating MLC bits and SLC bits to respective pages, a page round sequence may be used to order accesses to the memory array to avoid one or more types of successive-adjacent MLC-MLC accesses. For example, page round sequence 640 may avoid successive-adjacent MLC-MLC accesses along a direction of a wordline and/or successive-adjacent MLC-MLC accesses along a direction of a bitline.

In the table of FIG. 6 which represents page round sequence 640, rows correspond to wordlines and columns correspond to combinations of even/odd bitlines and first/second bits. Each cell of the table represents a page accessed with the wordline corresponding to the table row for that cell, where bits of the page are of the bit type corresponding to the table column for that cell, and are accessed with bitlines of the bitline type corresponding to the table column for that cell. The respective numbers in the cells represent the order of each page in the page round sequence 640. Shaded cells represent unused bit capacity of memory cells which are serving as SLCs—e.g. where the respective first bits of such SLCs are the exclusive bits of such SLCs.

A review of the sequence 640 reveals that no page round which might access a given MLC of a cell-contiguous plurality of memory cells is immediately succeeded by another page round which might access some other MLC of the cell-contiguous plurality of memory cells which is cell-adjacent to that given MLC.

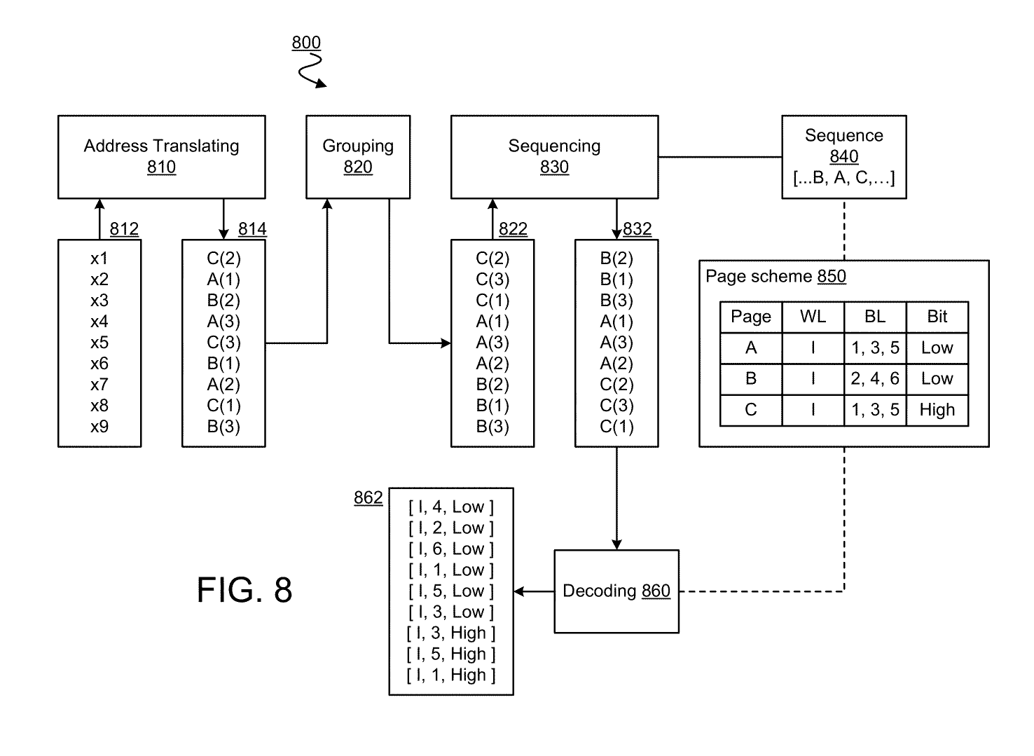

FIG. 7 illustrates elements of a method 700 for determining an order of memory accesses according to an embodiment. Method 700 may be performed by a device including some or all of the features of memory device 600, for example.

Method 700 may include, at 710, receiving information for accessing a memory array which includes a cell-contiguous set of memory cells. The cell-contiguous set may, for example, comprise first memory cells to operate as multi-level cells (MLCs) and second memory cells to operate as single-level cells (SLCs). In an embodiment, at least some of the first memory cells are interleaved with at least some of the second memory cells—e.g. wherein the cell-contiguous set of memory cells includes multiple cell-adjacent MLC-SLC pairs. Such cell-adjacent MLC-SLC pairs may include a pair of cells adjacent to one another along a direction of the cell activation line—e.g. a direction of a word line or a direction of a bit line. For example, a distribution of the first memory cells and a distribution of the second memory cells may form a checkered distribution pattern. The cell-contiguous set of memory cells may have an average of one and a half bits per cell, although certain embodiments are not limited in this regard.

In an embodiment, bits of the cell-contiguous set of memory cells belong to respective pages of a plurality of logical pages. The memory array may include a plurality of word lines—e.g. each word line corresponding to a different respective set of logical pages. For each of such a plurality of word lines, the set of logical pages corresponding to the word line may include a first logical page for first bits of MLCs which are to be accessed with the word line, a second logical page for second bits of MLCs which are to be accessed with the word line, and a third logical page for exclusive bits of SLCs which are to be accessed with the word line. Method 700 may further include, at 720, generating, based on the information received at 710, signals to order accesses to the cell-contiguous set of memory cells according to a sequence of page rounds. Ordering the access according to the page round sequence may, in an embodiment, be to avoid an occurrence of an access event which includes a successive-adjacent MLC-MLC access, in which cell-adjacent MLCs are accessed in respective ones of successive page rounds.

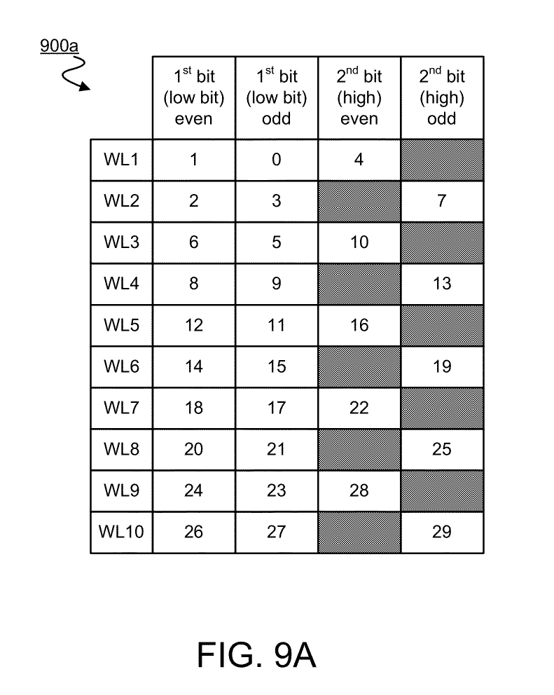

FIG. 8 illustrates elements of a sequence 800 of operations for ordering memory accesses according to an embodiment. Sequence 800 may be performed by one or more components of computer platform 300, for example. In a very simplified scenario, process 800 is shown determining an order of accesses to a set of pages which includes logical pages A, B and C which, in turn, each include respective locations labeled (1), (2) and (3).

In the illustrative scenario, a set 812 of addresses x1, . . . , x9—e.g. logical addresses—are input for address translating 810, which determines for each of addresses x1, . . . , x9 a corresponding page/location combination within pages A, B and C. Address translating 810 may provide a set 814 of page/location combinations for respective ones of addresses x1, . . . , x9. The set 814 may in turn be provided as input for a grouping 820 to group page/location combinations—e.g. based on respective pages of the page/location combinations.

For example, grouping 820 may result in a set 822 of page/location combinations which are grouped—e.g. ordered—according to their respective pages. Set 822 may in turn be provided as input for a sequencing 830 according to an embodiment. Sequencing 830 may, for example, be performed by a device having some or all of the features of memory device 600—e.g. where sequencing 830 is performed according to method 700. By way of illustration and not limitation, sequencing 840 may order the set 822 according to a sequence 840 of page rounds—e.g. where sequence 840 includes a page round for accessing page B, followed by a page round for accessing page A, followed by a page round for accessing page C.

The sequence 840 may be associated with a page scheme 850 which allocates bits in the memory array to respective logical pages—e.g. where the sequence 840 is to avoid one or more types of successive-adjacent MLC-MLC accesses to pages of the memory array which are according to page scheme 850. For example, pages A, B and C may each have respective bits which are variously accessed with the same wordline I, where bits of pages A and C are variously accessed with odd bitlines, whereas bits of page B are accessed with even bitlines. Moreover, bits of pages A and B may be variously accessed with a comparatively lower readout voltage, whereas bits of page C may be accessed with a comparatively higher readout voltage. Page scheme 850 is illustrative of one page scheme with which a sequence such as sequence 840 may be associated.

Sequencing 830 may result in an ordered set 832 of page/location combinations which, per sequence 840, orders accesses to page B before accesses to page A which, in turn, are before accesses to page C. Ordered set 832 may then be provided for decoding to generate a sequence 862 of signals—e.g. wordline signals and bitline signals for various respective accesses to first/second (e.g. low/high) bits of memory cells in the memory array.

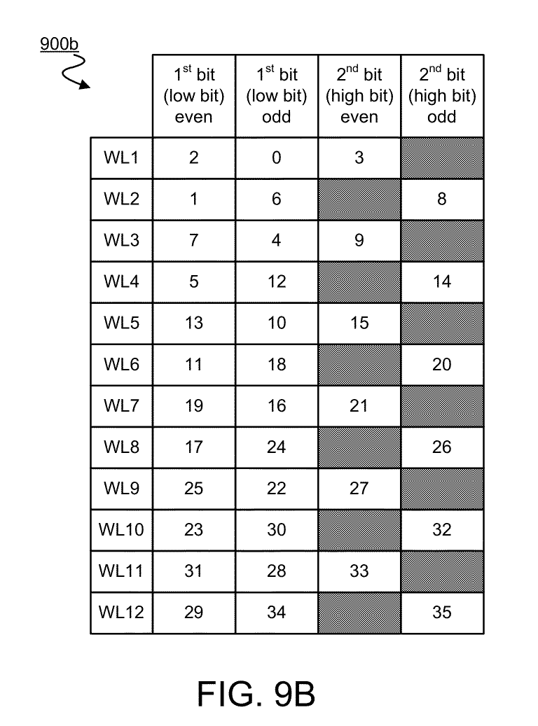

FIG. 9A and 9B illustrate respective page round sequences 900a, 900b for variously ordering memory accesses according to different embodiments. Page round sequences 900a, 900b may each be used to order accesses to a cell-contiguous set of memory cells in a memory array—e.g. the cell-contiguous set having a checkered MLC-SLC distribution pattern such as that of memory array 500. A review of page round sequences 900a, 900b reveals that ordering accesses according to either of page round sequences 900a, 900b may avoid successive-adjacent MLC-MLC accesses along a direction of a wordline and/or successive-adjacent MLC-MLC accesses along a direction of a bitline.

In a page round sequence—e.g. some or all of page round sequences 640, 900a, 900b—the exclusive bits of SLCs may be readout according to the same techniques for reading out the low bits of the MLCs. For example, exclusive bits of SLCs and the lower bits of MLCs may have the same threshold voltage distributions or are otherwise accessed with the same readout voltage. However, certain embodiments further provide mechanisms for distinguishing techniques for reading out an MLC lower bit from techniques for reading out a SLC exclusive bit.

By way of illustration and not limitation, control logic such as that in control engine 436 may include or otherwise have access to one or more registers which define various voltage levels for variously accessing different bits of MLCs and SLCs. Such registers may, for example, define for each of various bit types—e.g. one or more of a low bit of an MLC, a high bit of an MLC and an exclusive bit of a SLC—a respective read reference voltage level and/or a respective program verify voltage level. A read reference voltage level refers to a voltage level to be applied for determining a value stored in a bit of the corresponding bit type. A program verify voltage level refers to a voltage level to be applied for determining whether programming of a bit of the corresponding bit type was successful. Any of a variety of additional or alternative bit access voltage levels may be defined, according to different embodiments.

Registers in control engine 436 or similar control logic may distinguish from one another respective voltage levels—e.g. read reference voltage levels and/or program verify voltage levels—for SLC exclusive bits and for MLC low bits. Such distinguishing may, for example, allow for better resolution for determining logical values stored in SLC exclusive bits, without increasing the chance of errors associated with accessing MLC bits. In an embodiment, registers to define bit access voltage levels may be dynamically set/reset—e.g. with an on-the-fly set feature command—to configure a memory system for operation according to techniques discussed herein.

In addition to avoiding successive-adjacent MLC-MLC accesses, a page round sequence may further avoid or otherwise limit the occurrence of certain other access events. For example, a MLC may be particularly prone to FG-FG coupling with an adjacent memory cell (e.g. either an adjacent MLC or an adjacent SLC) during a period of time between a programming of a lower bit of that MLC and a programming of a higher bit of that MLC. The lower bit and the higher bit of the MLC may correspond, respectively, to a lower readout voltage and a comparatively higher readout voltage. Certain embodiments prevent the accessing of any cell which is wordline-adjacent or bitline-adjacent to such an MLC during a period between the accessing of that MLC's lower bit and the subsequent accessing of that MLC's higher bit.

For example, in page round sequence 640, page rounds 6 and 8 allow programming of a cell which is wordline-adjacent or bitline-adjacent to an MLC between the programming of that MLC's lower bit in page round 5 and an programming of that MLC's higher bit in page round 10. By contrast, page round sequence 900b any programming of a cell which is wordline-adjacent or bitline-adjacent to an MLC (in one or page rounds 1, 4 and 5) does not take place between the programming of that MLC's lower bit in page round 7 and a programming of that MLC's higher bit in page round 9.

Techniques and architectures for accessing a memory array are described herein. In the above description, for purposes of explanation, numerous specific details are set forth in order to provide a thorough understanding of certain embodiments. It will be apparent, however, to one skilled in the art that certain embodiments can be practiced without these specific details. In other instances, structures and devices are shown in block diagram form in order to avoid obscuring the description.

Reference in the specification to “one embodiment” or “an embodiment” means that a particular feature, structure, or characteristic described in connection with the embodiment is included in at least one embodiment of the invention. The appearances of the phrase “in one embodiment” in various places in the specification are not necessarily all referring to the same embodiment.

Some portions of the detailed description herein are presented in terms of algorithms and symbolic representations of operations on data bits within a computer memory. These algorithmic descriptions and representations are the means used by those skilled in the computing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise as apparent from the discussion herein, it is appreciated that throughout the description, discussions utilizing terms such as “processing” or “computing” or “calculating” or “determining” or “displaying” or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Certain embodiments also relate to apparatus for performing the operations herein. This apparatus may be specially constructed for the required purposes, or it may comprise a general purpose computer selectively activated or reconfigured by a computer program stored in the computer. Such a computer program may be stored in a computer readable storage medium, such as, but is not limited to, any type of disk including floppy disks, optical disks, CD-ROMs, and magnetic-optical disks, read-only memories (ROMs), random access memories (RAMs) such as dynamic RAM (DRAM), EPROMs, EEPROMs, magnetic or optical cards, or any type of media suitable for storing electronic instructions, and coupled to a computer system bus.

The algorithms and displays presented herein are not inherently related to any particular computer or other apparatus. Various general purpose systems may be used with programs in accordance with the teachings herein, or it may prove convenient to construct more specialized apparatus to perform the required method steps. The required structure for a variety of these systems will appear from the description herein. In addition, certain embodiments are not described with reference to any particular programming language. It will be appreciated that a variety of programming languages may be used to implement the teachings of such embodiments as described herein.

Besides what is described herein, various modifications may be made to the disclosed embodiments and implementations thereof without departing from their scope. Therefore, the illustrations and examples herein should be construed in an illustrative, and not a restrictive sense. The scope of the invention should be measured solely by reference to the claims that follow.

What is claimed is:

1. A memory device comprising:
a hardware interface to receive information for accessing a memory array including a cell-contiguous set of memory cells comprising first memory cells to operate as multi-level cells (MLCs) and second memory cells at least partially interleaved with the first memory cells, the second memory cells to operate as single-level cells (SLCs), wherein bits of the cell-contiguous set of memory cells belong to respective pages of a plurality of logical pages;
a sequencer coupled to the hardware interface, the sequencer including circuit logic to generate, based on the received information, signals to order accesses to the cell-contiguous set of memory cells according to a sequence of page rounds to avoid an occurrence of an access event in which a bit of a first MLC is accessed during a first page round and a bit of a second MLC is accessed during a second page round immediately succeeding the first page round in the sequence of page rounds, and wherein the first MLC and the second MLC are cell-adjacent to one another in a direction of a cell activation line.

2. The memory device of claim 1, the cell-contiguous set of memory cells having an average of one and a half bits per cell.

3. The memory device of claim 1, wherein the direction of the cell activation line is a direction of a word line of the memory array.

4. The memory device of claim 1, wherein the direction of the cell activation line is a direction of a bit line of the memory array.

5. The memory device of claim 1, wherein a distribution of the first memory cells and a distribution of the second memory cells form a checkered distribution pattern.

6. The memory device of claim 1, the memory array further including a first word line, wherein a first logical page includes first bits of the first memory cells which are to be accessed with the first word line, wherein a second logical page includes second bits of the first memory cells which are to be accessed with the first word line, wherein a third logical page includes exclusive bits of the second memory cells which are to be accessed with the first word line.

7. The memory device of claim 6, wherein the first logical page corresponds to first bits of MLCs, wherein the second logical page corresponds to second bits of MLCs, and wherein the third logical page corresponds to exclusive bits of SLCs.

8. The memory device of claim 1, the memory array including a plurality of word lines, each word line corresponding to a different respective set of logical pages.

9. The memory device of claim 8, wherein, for each of the plurality of word lines, each logical page of the set of logical pages corresponding to the word line corresponds to a different respective one of:
first bits of MLCs which are to be accessed with the word line;
second bits of MLCs which are to be accessed with the word line; and
exclusive bits of SLCs which are to be accessed with the word line.

10. A method comprising:
receiving information for accessing a memory array including a cell-contiguous set of memory cells comprising first memory cells to operate as multi-level cells (MLCs) and second memory cells at least partially interleaved with the first memory cells, the second memory cells to operate as single-level cells (SLCs), wherein bits of the cell-contiguous set of memory cells belong to respective pages of a plurality of logical pages; and
generating, based on the received information, signals to order accesses to the cell-contiguous set of memory cells according to a sequence of page rounds to avoid an occurrence of an access event in which a bit of a first MLC is accessed during a first page round and a bit of a second MLC is accessed during a second page round immediately succeeding the first page round in the sequence of page rounds, and wherein the first MLC and the second MLC are cell-adjacent to one another in a direction of a cell activation line.

11. The method of claim 10, the cell-contiguous set of memory cells having an average of one and a half bits per cell.

12. The method of claim 10, wherein the direction of the cell activation line is a direction of a word line of the memory array.

13. The method of claim 10, wherein the direction of the cell activation line is a direction of a bit line of the memory array.

14. The method of claim 10, wherein a distribution of the first memory cells and a distribution of the second memory cells form a checkered distribution pattern.

15. The method of claim 10, the memory array further including a first word line, wherein a first logical page includes first bits of the first memory cells which are to be accessed with the first word line, wherein a second logical page includes second bits of the first memory cells which are to be accessed with the first word line, wherein a third logical page includes exclusive bits of the second memory cells which are to be accessed with the first word line.

16. The method of claim 15, wherein the first logical page corresponds to first bits of MLCs, wherein the second logical page corresponds to second bits of MLCs, and wherein the third logical page corresponds to exclusive bits of SLCs.

17. The method of claim 10, the memory array including a plurality of word lines, each word line corresponding to a different respective set of logical pages.

18. The method of claim 17, wherein, for each of the plurality of word lines, each logical page of the set of logical pages corresponding to the word line corresponds to a different respective one of:
first bits of MLCs which are to be accessed with the word line;
second bits of MLCs which are to be accessed with the word line; and
exclusive bits of SLCs which are to be accessed with the word line.

19. A computer platform comprising:
a processor;
a memory device coupled to the processor, the memory device including:
a hardware interface to receive from the processor information for accessing a memory array of the computer platform, the memory array including a cell-contiguous set of memory cells comprising first memory cells to operate as multi-level cells (MLCs) and second memory cells at least partially interleaved with the first memory cells, the second memory cells to operate as single-level cells (SLCs), wherein bits of the cell-contiguous set of memory cells belong to respective pages of a plurality of logical pages; and
a sequencer coupled to the hardware interface, the sequencer including circuit logic to generate, based on the received information, signals to order accesses to the cell-contiguous set of memory cells according to a sequence of page rounds to avoid an occurrence of an access event in which a bit of a first MLC is accessed during a first page round and a bit of a second MLC is accessed during a second page round immediately succeeding the first page round in the sequence of page rounds, and wherein the first MLC and the second MLC are cell-adjacent to one another in a direction of a cell activation line; and
a network interface coupled to the processor and the memory device, the network interface to connect the computer platform to a network.

20. The computer platform of claim 19, the cell-contiguous set of memory cells having an average of one and a half bits per cell.

21. The computer platform of claim 19, wherein the direction of the cell activation line is a direction of a word line of the memory array.

22. The computer platform of claim 19, wherein the direction of the cell activation line is a direction of a bit line of the memory array.

23. The computer platform of claim 19, wherein a distribution of the first memory cells and a distribution of the second memory cells form a checkered distribution pattern.

24. The computer platform of claim 19, the memory array further including a first word line, wherein a first logical page includes first bits of the first memory cells which are to be accessed with the first word line, wherein a second logical page includes second bits of the first memory cells which are to be accessed with the first word line, wherein a third logical page includes exclusive bits of the second memory cells which are to be accessed with the first word line.

25. The computer platform of claim 24, wherein the first logical page corresponds to first bits of MLCs, wherein the second logical page corresponds to second bits of MLCs, and wherein the third logical page corresponds to exclusive bits of SLCs.

26. The computer platform of claim 19, the memory array including a plurality of word lines, each word line corresponding to a different respective set of logical pages.

27. The computer platform of claim 26, wherein, for each of the plurality of word lines, each logical page of the set of logical pages corresponding to the word line corresponds to a different respective one of:
first bits of MLCs which are to be accessed with the word line;
second bits of MLCs which are to be accessed with the word line; and
exclusive bits of SLCs which are to be accessed with the word line.
